(19) United States
(12) Patent Application Publication
(10) Pub. No.: US 2023/0405575 A1
(43) Pub. Date: Dec. 21, 2023

(54) Membranes

(71) Applicants: Fujifilm Manufacturing Europe BV, Tilburg (NL); Fujifilm Corporation, Tokyo (JP)

(72) Inventors: Adrianus Jacobus Van Rijen, Tilburg (NL); Takeshi Narita, Tilburg (NL); Elisa Huerta Martinez, Tilburg (NL); Jacko Hessing, Tilburg (NL)

(21) Appl. No.: 18/041,896

(22) PCT Filed: Sep. 27, 2021
(86) PCT No.: PCT/EP2021/076440

§ 371 Date: Feb. 16, 2023

(30) Foreign Application Priority Data
Sep. 30, 2020 (GB) 2015546.1

(51) Int. Cl. B01J 43/00; C08J 5/22; B01J 47/12; C08F 212/14; C08F 212/34; B01D 69/02; B01D 61/44; B01D 67/00

(52) U.S. Cl. CPC B01J 43/00; C08J 5/2231; B01J 47/12; C08F 212/30; C08F 212/34; B01D 2325/18; B01D 61/445; B01D 67/0013; C08J 2325/18; B01D 2325/42; B01D 69/02

(57) ABSTRACT

A membrane comprising an anion exchange layer (AEL) and a cation exchange layer (CEL) wherein the CEL is obtainable by a process comprising curing a curable composition comprising a compound of Formula (I): Formula (I) wherein: X is is of the formula —OCₙH₂ₙ₊₁ or —OC_{q}H2_{q-1}, wherein n has a value of of 1 to 6 and q has a value of 5 or 6; and m has a value of 1 or 2.

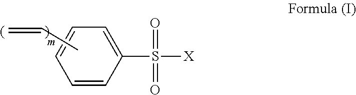

This invention relates to membranes (including bipolar membranes) and to processes for their preparation and use.

Ion exchange membranes are used in electrodialysis, reverse electrodialysis, electrolysis, diffusion dialysis and a number of other processes. Typically the transport of ions through the membranes occurs under the influence of a driving force such as an ion concentration gradient or, alternatively, an electrical potential gradient.

Ion exchange membranes are generally categorized as cation exchange membranes (CEMs) or anion exchange membranes (AEMs), depending on their predominant charge. Cation exchange membranes comprise negatively charged groups that allow the passage of cations but reject anions, while anion exchange membranes comprise positively charged groups that allow the passage of anions but reject cations. Bipolar membranes (BPMs) have both a cationic layer and an anionic layer.

Some bipolar membranes comprise a porous support which provides mechanical strength. Such membranes are often called “composite bipolar membranes” due to the presence of anionic and cationic polymers which discriminates between ions and the porous support which provides mechanical strength.

There is a desire to provide bipolar membranes having improved properties, e.g. high permselectivity, low electrical resistance, good mechanical strength and stability at extremes of pH. Ideally such bipolar membranes may be produced quickly, efficiently and cheaply.

According to a first aspect of the present invention there is provided a membrane comprising an anion exchange layer (AEL) and a cation exchange layer (CEL) wherein the CEL is obtainable by a process comprising curing a curable composition comprising a compound of Formula (I):

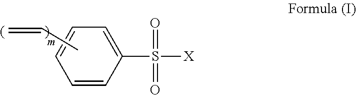

wherein:
X is of the formula —OCₙH₂ₙ₊₁ or —OC_{q}H_{2q-1}, wherein n has a value of 1 to 6 and q has a value of 5 or 6; and
m has a value of 1 or 2.

In this document (including its claims), the verb “comprise” and its conjugations is used in its non-limiting sense to mean that items following the word are included, but items not specifically mentioned are not excluded. In addition, reference to an element by the indefinite article “a” or “an” does not exclude the possibility that more than one of the elements is present, unless the context clearly requires that there be one and only one of the elements. The indefinite article “a” or “an” thus usually mean “at least one”. The composition used to form the AEL is often abbreviated herein to “the AEL composition”. Similarly the composition used to form the layer which is or becomes the CEL is often abbreviated herein to “the CEL composition”.

The —SO₂X group shown in Formula (I) is convertible to an anionic group and thus is useful for providing the CEL with anionic groups.

The —SO₂X group in Formula (I) (wherein X is as hereinbefore defined) is advantageous over analogous compounds wherein X is Cl or OSO₂R (wherein R is C₁₋₆-alkyl or C₆₋₁₂-aryl) due to their lower reactivity with nucleophiles. As a consequence, the compounds of Formula (I) wherein X is as hereinbefore defined have better stability than corresponding compounds wherein X is CI or OSO₂R (wherein R is C₁₋₆-alkyl or C₆₋₁₂-aryl).

The compounds of Formula (I) are known and many such compounds are available commercially.

In a preferred embodiment, m has a value of 1 or 2 and n has a value of 2 (i.e. X is ethyloxy) or q has a value of 6 (i.e. X is cyclohexyloxy).

Component (a) is preferably highly miscible with apolar compounds, for example non-charged aromatic molecules, e.g. with divinylbenzene.

Examples of compounds of Formula (I) include the following:

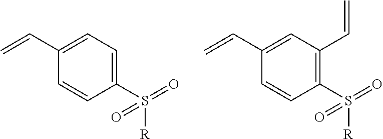

wherein R is X is —OCₙH₂ₙ₊₁ or —OC_{q}H_{2q-1}, wherein n has a value of 1 to 6 and q has a value of 5 or 6, for example methoxy, ethoxy, propoxy, tert-butoxy or cyclohexyloxy.

The curable composition from which the CEL may be obtained (i.e. “the CEL composition”) preferably comprises the following ingredients:
(a) the compound of Formula (I) (as hereinbefore defined);
optionally (b) a compound comprising at least two ethylenically unsaturated groups;
optionally (c) a non-aqueous solvent;
optionally (d) a radical initiator; and
optionally (e) an anionic monomer comprising one and only one ethylenically unsaturated group.

Preferably the CEL composition comprises component (b) and/or component (c).

Preferably the CEL composition comprises at least one, more preferably at least two, especially at least three and more especially all four of components (b), (c), (d) and (e) (as defined above).

Preferably the CEL composition comprises:
(a) 20 to 88 wt % of component (a);
(b) 10 to 60 wt % of component (b);
(c) 0 to 30 wt % of component (c);
(d) 0 to 2 wt % of component (d); and
(e) 0 to 15 wt % of component (e).

The preferences for the compound of Formula (I) used as component (a) in the CEL composition are as described above in relation to the first aspect of the present invention.

Preferably the CEL composition comprises 20 to 88 wt %, more preferably 30 to 80 wt %, most preferably 40 to 75 wt % of component (a).

Component (b) typically functions as a crosslinking agent and can provide CEL layers having a desirably high crosslinking density. A high crosslinking density is preferred to limit swelling of the bipolar membrane when in aqueous environments.

Preferably component (b) comprises an aromatic group, e.g. a phenyl or phenylene group (e.g. as is found in styrene).

Preferred ethylenically unsaturated groups include (meth)acrylic groups and/or vinyl groups (e.g. vinyl ether groups, aromatic vinyl compounds, N-vinyl compounds and allyl groups).

Examples of suitable (meth)acrylic groups include acrylate (H₂C═CHCO—) groups, acrylamide (H₂C═CHCONH—) groups, methacrylate (H₂C═C(CH₃)CO—) groups and methacrylamide (H₂C═C(CH₃)CONH—) groups. Acrylic groups are preferred over methacrylic groups because acrylic groups are more reactive.

Preferred ethylenically unsaturated groups are free from ester groups because this can improve the stability and the pH tolerance of the resultant composition. Ethylenically unsaturated groups which are free from ester groups include vinyl groups.

As examples of compounds which may be used as component (b) there may be mentioned the following:

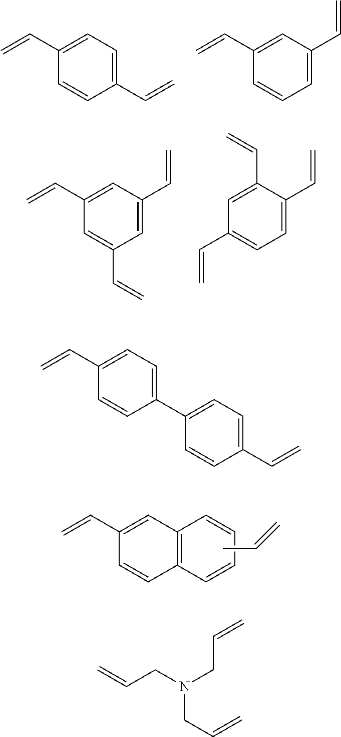

The above materials which may be used as component (b) can be obtained for commercial sources, for example from Sigma-Aldrich.

It is especially preferred that component (b) is or comprises divinylbenzene because this compound is widely available at low cost (often as a mixture of isomers).

Preferably the CEL composition comprises 10 to 60 wt %, more preferably 20 to 60 wt %, most preferably 20 to 55 wt % of component (b).

The molar ratio of component (a) to component (b) is preferably in the range of 3:1 to 1:2, more preferably 2:1 to 1:2 and especially 2:1 to 1:1, respectively.

Component (c) is preferably inert, i.e. incapable of reacting with any of the other components of the CEL composition.

Preferably component (c) is miscible with the other compounds of the CEL composition. Thus component (c) may be used to dilute the other components of the CEL composition to provide a low viscosity CEL composition suitable for use in coating machines and apparatus.

As examples of non-aqueous solvents which may be used as component (c) of the CEL composition there may be mentioned alcohol-based solvents, ether-based solvents, amide-based solvents, ketone-based solvents, sulfoxide-based solvents, sulfone-based solvents, nitrile-based solvents and organic phosphorus based solvents. Examples of alcohol-based solvents which may be used as or in component (c) include methanol, ethanol, isopropanol, n-butanol, ethylene glycol, propylene glycol, diethylene glycol, dipropylene glycol and mixtures comprising two or more thereof. In addition, preferred inert, organic solvents which may be used in component (c) include dimethyl sulfoxide, dimethyl imidazolidinone, sulfolane, N-methyl pyrrolidone, dimethyl formamide, acetonitrile, acetone, 1,4-dioxane, 1,3-dioxolane, tetramethyl urea, hexamethyl phosphoramide, hexamethyl phosphorotriamide, pyridine, propionitrile, butanone, cyclohexanone, tetrahydrofuran, tetrahydropyran, 2-methyltetrahydrofuran, ethylene glycol diacetate, cyclopentylmethylether, methylethylketone, ethyl acetate, y-butyrolactone and mixtures comprising two or more thereof. Dimethyl sulfoxide, N-methyl pyrrolidone, dimethyl formamide, dimethyl imidazolidinone, sulfolane, acetone, cyclopentylmethylether, methylethylketone, acetonitrile, tetrahydrofuran, 2-methyltetrahydrofuran and mixtures comprising two or more thereof are preferable.

Other examples of component (c) of the CEL composition include apolar non-protic solvents, e.g. toluene, xylene, chloroform, dichloromethane, pyrrole, N-methyl pyrole, pyridine, pyrazine, and mixtures comprising two or more of the foregoing.

Preferably the CEL composition comprises a small amount of component (c) to enable the preparation of a dense CEL. If a large amount of component (c) is present in the CEL composition during curing a film (or CEL) having an open structure may be formed in which component (c) fills the open spaces. After drying, such open structures tend to swell in aqueous environments leading to a reduced permselectivity, which is not desirable.

Preferably the CEL composition comprises 0 to 30 wt % of component (c), more preferably 4 to 20 wt %, especially 2 to 15 wt % of component (c).

Component (d) of the CEL composition preferably is or comprises a thermal initiator, a photo initiator or a combination thereof. Most preferably component (d) is or comprises a thermal initiator.

Examples of thermal initiators include 2,2′-azobis(2-methylpropionitrile) (AIBN), 4,4′-azobis(4-cyanovaleric acid), 2,2′-azobis(2,4-dimethyl valeronitrile), 2,2′-azobis(2-methylbutyronitrile), 1,1′-azobis(cyclohexane-1-carbonitrile), 2,2′-azobis(4-methoxy-2,4-dimethyl valeronitrile), dimethyl 2,2′-azobis(2-methylpropionate), 2,2′-azobis[N-(2-propenyl)-2-methylpropionamide, 1-[(1-cyano-1-methylethyl)azo]formamide, 2,2′-Azobis(N-butyl-2-methylpropionamide), 2,2′-Azobis(N-cyclohexyl-2-methylpropionamide), 2,2′-Azobis(2-methylpropionamidine) dihydrochloride, 2,2′-Azobis[2-(2-imidazolin-2-Apropane]dihydrochloride, 2,2′-Azobis[2-(2-imidazolin-2-yl)propane]disulfate dihydrate, 2,2′-Azobis[N-(2-carboxyethyl)-2-methylpropionamidine]hydrate, 2,2′-Azobis{2[-(2-hydroxyethyl)-2-imidazolin-2-yl]propane}dihydrochloride, 2,2′-Azobis[2-(2-imidazolin-2-yl)propane], 2,2′-Azobis(1-imino-1-pyrrolidino-2-ethylpropane) dihydrochloride, 2,2′-Azobis{2-methyl-N-[1,1-bis(hydroxymethyl)-2-hydroxyethl]propionam ide} and 2,2′-Azobis[2-methyl-N-(2-hydroxyethyl)propionamide].

Preferably the CEL composition is free from component (d) or comprises 0.001 to 2 wt %, more preferably 0.2 to 1 wt % of component (d). When the CEL composition is to be cured by electron beam (EB) or gamma radiation then component (d) is not necessary.

Optionally the CEL composition further comprises a small amount of component (e). Component (e) can be useful for providing the CEL with a small degree of hydrophilicity which aids to speed up hydrolysis processes.

Examples of anionic monomers comprising one and only one ethylenically unsaturated group which may be used as component (e) include sulfonated styrene in free acid or salt form, especially in the form of a lithium salt, a sodium salt or a mixed lithium and sodium salt.

Preferably the CEL composition contains 0 to 15 wt %, more preferably less than 15 wt %, of component (e).
In one embodiment the CEL composition and/or the AEL composition comprises at least 60 wt % of curable compounds.

Preferably the membranes of the present invention comprise a porous support. A porous support may be included in the CEL, in the AEL, at the junction between the AEL and the CEL or in two or more of the aforementioned locations. Also more than one porous support may be provided in each location.

As examples of porous supports there may be mentioned woven and non-woven synthetic fabrics and extruded films. Examples include wetlaid and drylaid non-woven material, spunbond and meltblown fabrics and nanofiber webs made from, e.g. polyethylene, polypropylene, polyacrylonitrile, polyvinyl chloride, polyphenylenesulfide, polyester, polyamide, polyaryletherketones such as polyether ether ketone and copolymers thereof. Porous supports may also be porous membranes, e.g. polysulfone, polyethersulfone, polyphenylenesulfone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene and polychlorotrifluoroethylene membranes and derivatives thereof.

The porous support preferably has an average thickness of between 10 and 200 μm, more preferably between 20 and 150 μm. Preferably the porous support has a porosity of 30 and 95%. The porosity of the support may be determined by a porometer, e.g. a Porolux™ 1000 from IB-FT GmbH, Germany.

The porous support, when present, may be treated to modify its surface energy, e.g. to values above 45 mN/m, preferably above 55 mN/m. Suitable treatments include corona discharge treatment, plasma glow discharge treatment, flame treatment, ultraviolet light irradiation treatment, chemical treatment or the like, e.g. for the purpose of improving the wettability of and the adhesiveness to the porous support.

Commercially available porous supports are available from a number of sources, e.g. from Freudenberg Filtration Technologies (Novatexx materials), Lydall Performance Materials, Celgard LLC, APorous Inc., SWM (Conwed Plastics, DelStar Technologies), Teijin, Hirose, Mitsubishi Paper Mills Ltd and Sefar AG.

Preferably the support is a polymeric support. Preferably the support is a woven or non-woven synthetic fabric or an extruded film without covalently bound ionic groups.

The membrane according to the first aspect of the present invention is preferably a bipolar membrane or a membrane which is convertible by hydrolysis to a bipolar membrane.

The AEL of the membranes of the present invention is preferably obtainable by curing a composition comprising a curable cationic compound (i.e. ‘the AEL composition’). Thus the AEL composition preferably comprises a curable cationic compound (referred to in the composition described below as component (a2)).

A preferred curable cationic compound comprises at least two ethylenically unsaturated groups, e.g. a compound of Formula (II):

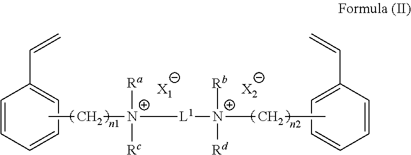

wherein:

L¹ is an alkylene group or an alkenylene group;
R^{a}, R^{b}, R^{c}, and R^{d} are each independently an alkyl group or an aryl group, or 20 R^{a} and R^{b},and/or R^{c} and R^{d} may, together with the atoms to which they are attached, form a ring;
n1 and n2 each independently represent an integer of 1 to 10; and
X₁⁻ and X₂⁻ each independently represent an anion.

L¹ is preferably ethylene, propylene, hexylene or vinylene.

When any of R^{a}, R^{b}, R^{c}, and R^{d} is an alkyl group it is preferably a C₁₋₄-alkyl group, especially methyl.

When any of R^{a}, R^{b}, R^{c}, and R^{d} is an aryl group it is preferably a C₆₋₁₀-aryl group, especially phenyl.

When R^{a} and R^{b},and/or R^{c} and R^{d}, together with the atoms to which they are attached, form a ring, the ring is preferably a 5-or 6-membered ring.

The anions represented by X₁⁻ and X₁⁻ l are preferably each independently halo, especially Cl⁻.

Thus AEL composition preferably comprises the following ingredients:
(a2) a curable cationic compound comprising at least two ethylenically unsaturated groups;
   optionally (b2) a compound comprising one and only one ethylenically unsaturated group;
   optionally (c2) a solvent; and
   optionally (d2) a radical initiator.

Preferably the AEL composition comprises at least one, more preferably at least two, especially all three of components (b2), (c2) and (d2).

Examples of compounds of Formula (II) include the following:

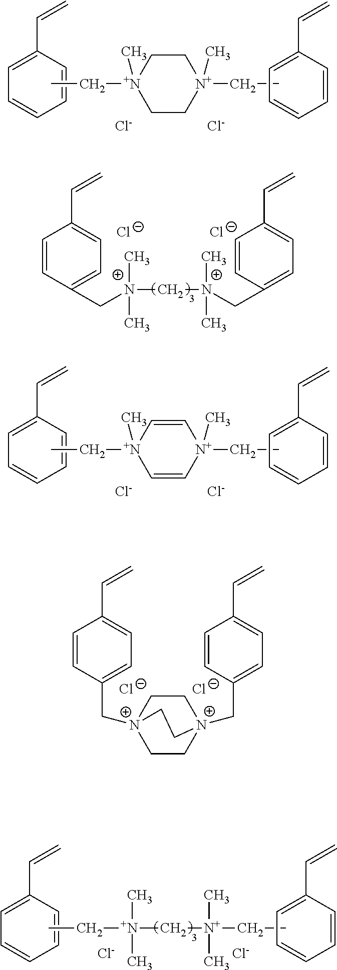

Synthesis methods can be found in e.g. EP3184558 and US2016/0001238.

The AEL composition preferably comprises 30 to 80 wt % of the compound of component (a2), more preferably between 40 and 70 wt % of component (a2).

Preferably the AEL composition comprises:
(i) to 80 wt % of component (a2);
(ii) 0 to 40 wt % of component (b2); and
(iii) 10 to 40 wt % of component (c2).

Component (b2) preferably comprises an aromatic group.

Component (b2) preferably comprises a cationic group.

Examples of compounds which may be used as component (b2) of the AEL composition include the following:

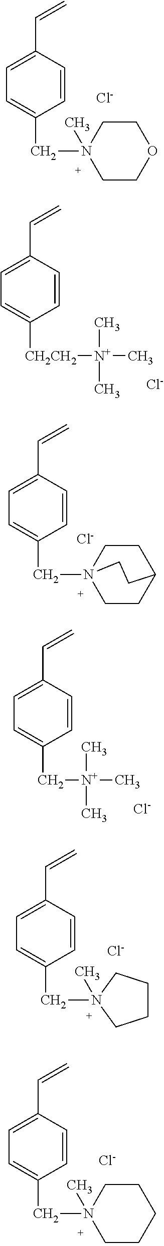

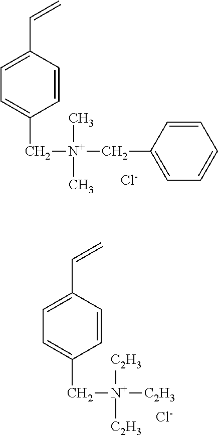

The above compounds may be prepared as described in, for example,. US2016177006.

Preferably the molar ratio of component (a2) to component (b2) in the AEL composition is in the range 9:1 to 1:4.

The AEL composition comprises 0 to 60 wt %, more preferably 5 to 45 wt %, most preferably 10 to 40 wt % of component (b2).

Component (c2) of the AEL composition preferably comprises water and optionally an organic solvent, especially where some or all of the organic solvent is water-miscible. The water is useful for dissolving the compound of Formula (II) and component (c2), when present. The solvent is useful for reducing the viscosity and/or surface tension of the composition.

Examples of suitable solvents which may be used as component (c2) of the AEL composition include water, alcohol-based solvents, ether-based solvents, amide-based solvents, ketone-based solvents, sulfoxide-based solvents, sulfone-based solvents, nitrile-based solvents, organic phosphorus based solvents and mixtures comprising two or more thereof. Examples of alcohol-based solvents which may be used as or in component (ii) (especially in combination with water) include methanol, ethanol, isopropanol, n-butanol, ethylene glycol, propylene glycol, diethylene glycol, dipropylene glycol and mixtures comprising two or more thereof. In addition, preferred inert, organic solvents which may be used in component (ii) include dimethyl sulfoxide, dimethyl imidazolidinone, sulfolane, N-methylpyrrolidone, dimethyl formamide, acetonitrile, acetone, 1,4-dioxane, 1,3-dioxolane, tetramethyl urea, hexamethyl phosphoramide, hexamethyl phosphorotriamide, pyridine, propionitrile, butanone, cyclohexanone, tetrahydrofuran, tetrahydropyran, 2-methyltetrahydrofuran, ethylene glycol diacetate, cyclopentylmethylether, methylethylketone, ethyl acetate, y-butyrolactone and mixtures comprising two or more thereof. Dimethyl sulfoxide, N-methyl pyrrolidone, dimethyl formamide, dimethyl imidazolidinone, sulfolane, acetone, cyclopentylmethylether, methylethylketone, acetonitrile, tetrahydrofuran, 2-methyltetrahydrofuran and mixtures comprising two or more thereof are preferable.

In some embodiments, the AEL composition comprises 10 to 40 wt %, more preferably 10 to 35 wt %, most preferably 15 to 30 wt % of component (c2).

Examples of components (c2) to (d2) which may be included in the AEL composition used to form the AEL are as described above in relation to the CEL composition as components (c) and (d) respectively. However component (c2) of the AEL composition is preferably aqueous.

Component (d2) preferably is or comprises a thermal initiator, a photoinitiator or a combination thereof. Most preferably component (d) is or comprises a photoinitiator.

Examples of suitable photoinitiators which may be used as component (d2) of the AEL composition include aromatic ketones, acylphosphine compounds, aromatic onium salt compounds, organic peroxides, thio compounds, hexaarylbiimidazole compounds, ketoxime ester compounds, borate compounds, azinium compounds, metallocene compounds, active ester compounds, compounds having a carbon halogen bond, and an alkyl amine compounds.

Preferred examples of the aromatic ketones, the acylphosphine oxide compound, and the thio-compound include compounds having a benzophenone skeleton or a thioxanthone skeleton described in “RADIATION CURING IN POLYMER SCIENCE AND TECHNOLOGY”, pp. 77-117 (1993). More preferred examples thereof include an alpha-thiobenzophenone compound described in JP1972-6416B (JP-S47-6416B), a benzoin ether compound described in JP1972-3981B (JP-S47-3981B), an alpha-substituted benzoin compound described in JP1972-22326B (JP-S47-22326B), a benzoin derivative described in JP1972-23664B (JP-S47-23664B), an aroylphosphonic acid ester described in JP1982-30704A (JP-S57-30704A), dialkoxybenzophenone described in JP1985-26483B (JP-S60-26483B), benzoin ethers described in JP1985-26403B (JP-S60-26403B) and JP1987-81345A (JPS62-81345A), alpha-amino benzophenones described in JP1989-34242B (JP H01-34242B), U.S. Pat. No. 4,318,791A, and EP0284561A1, p-di(dimethylaminobenzoyl)benzene described in JP1990-211452A (JP-H02-211452A), a thio-substituted aromatic ketone described in JP1986-194062A (JPS61-194062A), an acylphosphine sulfide described in JP1990-9597B (JP-H02-9597B), an acylphosphine described in JP1990-9596B (JP-H02-9596B), thioxanthones described in JP1988-61950B (JP-S63-61950B), and coumarins described in JP1984-42864B (JP-S59-42864B). In addition, the photoinitiators described in JP2008-105379A and JP2009-114290A are also preferable. In addition, photoinitiators described in pp. 65 to 148 of “Ultraviolet Curing System” written by Kato Kiyomi (published by Research Center Co., Ltd., 1989) may be used.

Especially preferred photoinitiators which may be used as component (d2) of the AEL composition include Norrish Type II photoinitiators having an absorption maximum at a wavelength longer than 380 nm, when measured in one or more of the following solvents at a temperature of 23° C.: water, ethanol and toluene. Examples include a xanthene, flavin, curcumin, porphyrin, anthraquinone, phenoxazine, camphorquinone, phenazine, acridine, phenothiazine, xanthone, thioxanthone, thioxanthene, acridone, flavone, coumarin, fluorenone, quinoline, quinolone, naphtaquinone, quinolinone, arylmethane, azo, benzophenone, carotenoid, cyanine, phtalocyanine, dipyrrin, squarine, stilbene, styryl, triazine or anthocyan in-derived photoinitiator.

The AEL composition preferably comprises 0.001 to 2 wt % of component (d2), more preferably 0.005 to 0.9 wt %.

The AEL composition and the CEL composition optionally each independently further comprise a polymerization Inhibitor. A polymerization Inhibitor can be useful for making the composition(s) stable during storage and use.

As the polymerization inhibitor, well-known polymerization inhibitors can be used. Examples thereof include phenol compounds, hydroquinone compounds, certain amine compounds, mercapto compounds, and nitroxyl radical compounds.

Examples of phenol compounds include hindered phenols (phenols having a t-butyl group in an ortho position, and representatively 2,6-di-t-butyl-4-methylphenol), and bisphenols. Specific examples of hydroquinone compounds include monomethyl ether hydroquinone. Specific examples of amine compounds include N-nitroso-N-phenyl hydroxylamine and N,N-diethylhydroxylamine. Specific examples of nitroxyl radical compounds include 4-hydroxy TEMPO (4-hydroxy-2,2,6,6-tetramethylpiperidine-1-oxyl free radical).

The AEL composition and the CEL composition optionally each independently further comprise two or more polymerisation inhibitors.

When the composition used to form the AEL or the CEL comprises a polymerization inhibitor the content is preferably 0.01 to 5 wt %, more preferably 0.01 to 1 wt %, and further preferably 0.01 to 0.5 wt %, relative to the total weight of the composition.

The AEL composition and the CEL composition optionally each independently further comprise a surfactant, a polymer dispersing agent and/or a crater inhibitor.

In order to adjust film physical properties of the AEL composition and/or CEL composition, various polymer compounds may be included therein. Suitable polymer compounds include acrylic polymers, polyurethane resins, polyamide resins, polyester resins, epoxy resins, phenol resins, polycarbonate resins, polyvinyl butyral resins, polyvinyl formal resins, shellac, vinylic resins, acrylic resins, rubber-based resins, waxes, and natural resins and combinations of two or more of the foregoing.

The AEL composition and the CEL composition optionally each independently further comprise a surfactant, e.g. a nonionic surfactant, a cationic surfactant, an organic fluoro surfactant, or the like. Specific examples of surfactants include anionic surfactants (e.g. an alkylbenzene sulfonic acid salt, alkylnaphthalene sulfonic acid salts, higher fatty acid salts, sulfonic acid salts of higher fatty acid esters, sulfuric acid ester salts of higher alcohol ethers, sulfonic acid salts of higher alcohol ethers, alkylcarboxylic acid salts of higher alkylsulfone amides and alkylphosphoric acid salts) and non-ionic surfactants (e.g. poly(oxyethylene) alkyl ethers, poly(oxyethylene) alkyl phenyl ethers, poly(oxyethylene) fatty acid esters, sorbitan fatty acid esters, ethylene oxide adducts of acetylene glycol, ethylene oxide adducts of glycerin, and polyoxyethylene sorbitan fatty acid esters). Other examples suitable surfactants include amphoteric surfactants (e.g. alkyl betaines and amide betaines), silicone-based surfactants and a fluorine-based surfactant. The surfactant can be suitably selected from the surfactant known in the art or a derivative thereof.

The AEL composition and the CEL composition optionally each independently further comprise a polymer dispersant.

Specific examples of the polymer dispersant include polyvinyl pyrrolidone, polyvinyl alcohol, polyvinyl methyl ether, polyethylene oxide, polyethylene glycol, polypropylene glycol and polyacryl amide. Among these, it is preferable to use polyvinyl pyrrolidone.

The AEL composition and the CEL composition optionally each independently further comprise a crater inhibitor (sometimes referred to as a surface conditioner), a levelling agent, or a slipping agent to prevent unevenness on the CEL or AEL surface, examples of which include organomodified polysiloxanes (mixtures of polyether siloxane and polyether), polyether-modified polysiloxane copolymers and silicon-modified copolymers.

Examples of the commercially available crater inhibitors which may be included in the compositions used to form AEL and/or the CEL include Tego Glide™ 432, Tego Glide™ 110, Tego Glide™ 130, Tego Glide™ 406, Tego Glide™ 410, Tego Glide™ 411, Tego Glide™ 415, Tego Glide™ 420, Tego Glide™ 435, Tego Glide™ 440, Tego Glide™ 450, Tego Glide™ 482, Tego Glide™ A115, Tego Glide™

B1484 and Tego GlideTM ZG400 (all are product names), manufactured by Evonik industries GmbH.

The AEL composition and the CEL composition preferably each independently comprise 0 to 10 wt %, more preferably 0 to 5 wt % and especially 1 to 2 wt % of crater inhibitor (relative to the total weight of the relevant composition).

In one embodiment the membranes according to the present invention comprise a catalyst. A catalyst may be included in the AEL composition and/or the CEL composition. Also it is possible to apply the catalyst (as a post-treatment step) to the AEL (e.g. before applying the CEL composition thereto) using, for example, (but not limited to), dipping, air knife coating, microroller coating, spraying, chemical (vapour) deposition) or physical (vapour) deposition.

Examples of suitable catalysts include metal salts, metal oxides, organometallic compounds, monomers, polymers or co-polymers. Examples include, but are not limited to, FeCl₃, FeCl₂, AlCl₃, MgCl₂, RuCl₃, CrCl₃, Fe(OH)₃, Al₂O₃, NiO, Zr(HPO₄)₂, MoS₂, graphene oxide, Fe-polyvinyl alcohol complexes, polyvinyl alcohol (PVA), polyethylene glycol (PEG), polyethyleneimine (PEI), polyacrylic acid (PAA), co-polymer of acrylic acid and maleic anhydride (PAAMA) and hyperbranched aliphatic polyester and combinations comprising two or more of the foregoing.

When the AEL composition or the CEL composition comprises a catalyst, the amount of catalyst is preferably up to 5 wt %, e.g. 0.001 wt % to 1 wt %, relative to the weight of the relevant composition. The amount of catalyst in the AEL and/or CEL, when the catalyst is present, is preferably up to 5 wt %, e.g. 0.001 wt % to 1 wt. %.

According to a second aspect of the present invention there is provided a process for manufacturing a membrane comprising the steps:
(i) applying the AEL composition to a support;
(ii) at least partly curing the AEL composition, thereby forming an anion exchange layer (AEL);
(iii) applying the CEL composition to the AEL; and
(iv) curing the CEL composition, thereby forming a cation exchange layer (CEL) on the AEL.

In step (ii) preferably the AEL composition is photocured, e.g. using ultraviolet light. Therefore preferably component (d2) of the AEL composition is or comprises a photoinitiator.

In step (ii), preferably the AEL composition is cured to such an extent that the resultant AEL can be processed in a curable composition application station while still having unreacted ethylenically unsaturated groups that are available for crosslinking to the monomers of the CEL composition.

In step (iv) the CEL composition is preferably cured thermally. Therefore preferably component (d) of the CEL composition is or comprises a thermal initiator.

A suitable temperature for curing the CEL composition is from 50 to 120° C., more preferably from 50 to 100° C., especially 60 to 85° C.

Thermal curing of the CEL composition typically takes from one minute or more to several hours.

Optionally the CEL composition is cured after being sandwiched between polymer films to prevent evaporation of component (c), when present.

In the process of the second aspect of the present invention, the compositions are preferably applied in step (i) and (iii) in a continuous manner, preferably by means of a manufacturing unit comprising composition application stations, one or more curing stations comprising irradiation source(s) when a composition is photocurable, one or more curing stations comprising a one or more heat source(s) when a composition is thermally curable, a membrane collecting station and a means for moving the supports from the composition application stations to the curing station(s) and to the membrane collecting station.

The composition application stations may be located at an upstream position relative to the curing station(s) and the curing station(s) is/are located at an upstream position relative to the membrane collecting station.

Examples of application techniques include slot die coating, slide coating, air knife coating, roller coating, screen printing, and dipping. Depending on the used technique and the desired end specifications, it might be necessary to remove excess composition from the substrate by, for example, roll-to-roll squeeze, roll-to-blade or blade-to-roll squeeze, blade-to-blade squeeze or removal using coating bars.

Photocuring by ultraviolet or visible light is preferably performed at a wavelength between 100 nm and 800 nm, typically using a dose of light of between and 1500 mJ/cm². Thermal curing is preferably performed at a temperature of between 20° C. and 100° C., e.g. for a period of 0.01 hour to 24 hours.

Optionally the process according to the second aspect further comprises of converting the group X into a hydroxyl group, e.g. by hydrolysis. In this way the membranes may be converted into bipolar membranes or into bipolar membranes having a larger number of acidic groups. Suitable hydrolysis methods include hydrolysis under acidic or alkaline conditions, e.g. using an acid (e.g. hydrochloric acid) or an alkali (e.g. a metal hydroxide, especially sodium hydroxide or potassium hydroxide).

According to a third aspect of the present invention there is provided a membrane comprising an anion exchange layer (AEL) and a layer comprising —SO₂X groups wherein X is as defined above.

According to a fourth aspect of the present invention there is provided a process for preparing a bipolar membrane comprising hydrolysing at least some the —SO₂X groups in the membrane according to the first aspect of the present invention to —SO₂OH groups or a salt thereof.

In one embodiment the process of the fourth aspect of the present invention the SO₂X groups are hydrolysed to —SO₂OH groups (in free acid or salt form) by contact with aqueous acid and/or alkali. The hydrolysis may be achieved by, for example, immersing the membrane of the first aspect of the present invention in aqueous acid and/or alkali, preferably at an elevated temperature (e.g. at 50 to 100° C.). The hydrolysis is preferably performed by contact with the aqueous acid and/or alkali for a total period of 1 hour to 1 month, especially 5 hours to 1 week. Optionally the aqueous acid and/or alkali comprises a surfactant.

Optionally the aqueous acid and/or alkali comprises a water-miscible organic solvent.

Preferably the aqueous acid and/or alkali is aqueous, especially at a strength of 0.05 to 1.0N.

Suitable acids include hydrochloric acid and sulphuric acid.

Suitable alkalis include sodium carbonate, ammonium hydroxide, tetramethyl ammonium hydroxide, potassium hydroxide and sodium hydroxide.

Optionally the acid and/or alkali comprises a polar solvents, e.g. dimethylsulphoxide, isopropylalcohol, dimethyl carbonate, ethyl methyl carbonate, diethyl carbonate, ethylene carbonate, propylene carbonate or two or more of the foregoing.

The extent of the hydrolysis can be monitored over time by infrared spectroscopy.

In one embodiment the process of the second aspect or fourth aspect of the present invention further comprises the step (vi) of drying the resultant membrane, preferably at a temperatures of between 40° C. and 200° C.

The membranes of the present invention may be manufactured by a number of alternative processes, including the processes described above.

The membranes of the present invention may be used for various applications, including electrodialysis and acid/base production. The present membranes comprising a CEL and an AEL may also be used as bipolar membranes, particularly as they have good durability in acidic and basic media, low swelling, and may be produced cheaply, quickly and efficiently.

The invention is further illustrated by the following Examples in which all parts and percentages are by weight unless specified otherwise.

The performance of the bipolar membranes according to the present invention were characterized by means of an intensity versus voltage plot. For measuring this plot a six compartment cell was used. The 1^{st} electrode compartment contained a platinum plate as cathode and was separated from the2^{nd} compartment by a CEM (CMX from Astom). The electrode compartment was filled with 0.5 M Na₂SO₄. Between the 2^{nd} and the 3^{rd} compartment a reference BPM (from Fumatech) was present. Both the 2^{nd} and the 3^{rd} compartment contained a 0.5M NaCl solution. Between the 3^{rd} and 4^{th} compartment the BPM to be analyzed was placed. Between the 4^{th} and the 5^{th} compartment the same reference BPM was placed (from Fumatech) and between the 5^{th} and the 6^{th} compartment a CEM (CMX from Astom). The 4^{th} and 5^{th} compartments are also filled with a 0.5M NaCl solution. The 6^{th} compartment containing a platinum plate as anode is an electrode compartment and contained 0.5 M Na₂SO₄.

By using the above cell the solutions were pumped through the compartments at a temperature of 25° C. and applying a current density of 600 A/m². Bipolar voltages were measured by using a Harber luggin capillary placed at each side of the BPM to be analyzed.

### Electrical Resistance

ER (ohm.cm 2) of the membranes (or their precursors) prepared in the

Examples was measured by the method described by Dlugolecki et al., J. of Membrane Science, 319 (2008) on page 217-218 with the following modifications:
the auxiliary membranes were CMX and AMX from Tokuyama Soda, Japan;
the capillaries as well as the Ag/AgCl references electrodes (Metrohm type 6.0750.100) contained 3M KCl;
the calibration liquid and the liquid in compartment 2, 3, 4 and 5 was 0.5 M NaCl solution at 25° C.;
the effective membrane area was 9.62 cm 2 ;
the distance between the capillaries was 5.0 mm;
the measuring temperature was 25° C.;
a Cole Parmer Masterflex console drive (77521-47) with easy load II model 77200-62 gear pumps was used for all compartments;
the flowrate of each stream was 475 ml/min controlled by Porter Instrument flowmeters (type 150AV-B250-4RVS) and Cole Parmer flowmeters (type G-30217-90); and he samples were equilibrated for at least 1 hour at room temperature in a 0.5 M solution of NaCl prior to measurement.

Preferably the ER (NaCl) of the membranes is lower than 5 ohm/cm².

### Permselectivity

The permselectivity (%) that is the selectivity to the passage of ions of opposite charge to that of the membranes (or their precursors) prepared in the examples, was measured as follows. The membrane to be analysed was placed in a two-compartment system. One compartment was filled with a 0.05M solution of NaOH and the other with a 0.5M solution of NaOH.

### Settings

the capillaries as well as the Ag/AgCl reference electrodes (Metrohm type 6.0750.100) contained 3M KCl;
the effective membrane area was 9.62 cm²;
the distance between the capillaries was ca 15 mm;
the measuring temperature was 21.0±0.2° C.;
a Cole Parmer Masterflex console drive (77521-47) with easy load II model 77200-62 gear pumps was used for the two compartments;
Porter Instrument flowmeters (type 150AV-B250-4RVS) and Cole Parmer flowmeters (type G-30217-90) were used to control the flow constant at 500 ml/min; The membrane samples were equilibrated for 1 h in a 0.5M NaOH solution prior to measurement. The voltage was read from a regular VOM (multitester) after 20 minutes.

The PS (NaOH) of the membranes was preferably above 70%.

### Infrared Spectroscopy

Conventional IR measurement was used as a detecting method for monitoring the hydrolysis of alkyl-sulfonic ester groups (—SO₂X in Formula (I)) into sulfonic acid groups (—SO₂OH or —SO₂OM where M is Na⁺, Li⁺ or K⁺) by following the intensity of the peak at 910 cm⁻¹. Spectra were collected in a Frontier FT-IR spectrophotometer from PerkinElmer equipped with a Diamond probe. The spectra were collected directly from the membranes after the excess of water was wiped off.

### NMR Spectroscopy

The structures of the compounds synthesized in the examples were confirmed by 1 H-NMR using a Magritek Spincolve 60 Carbon (60 MHz, 4 scans) NMR spectrometer. Samples for analysis were prepared by dissolving 5 wt % of each compound in a deuterated solved (indicated in the examples).

The abbreviations shown below were used in the Examples

| | Com- | |
|---|---|---|
| Abbre- | ponent | |
| viation | Type | Description/supplier |
| Et-SS | (a) | Ethyl vinylbenzenesulfonate from Tosoh |
| | | Chemicals |
| Et-DVBS | (b) | Ethyl divinylbenzenesulfonate prepared |
| | | as described below. |
| LiSS | (e) | Styrene sulfonate, lithium salt from |
| | | Tosoh chemicals |
| DVB | (b) | Divinylbenzene from Sigma-Aldrich |
| V-65B | (d) | 2,2′-Azobis(2,4-dimethylvaleronitrile) |
| | | from Fujifilm Wako Chemicals |
| DMSO | (c) | Dimethylsulphoxyde from Sigma- |
| | | Aldrich |
| IPA | (c) | Isopropanol from Sigma-Aldrich |
| 4-OH- | | 4-Hydroxy-2,2,6,6-tetramethylpiperidine |
| TEMPO | | 1-oxyl from Sigma-Aldrich |
| DMF | | Dimethylformamide from Sigma- |
| | | Aldrich |
| Celite | | Celite S, diatomaceous earth (SiO₂) |
| | | from Sigma-Aldrich |
| Na-AMPS | | Sodium salt of 2-acrylamideo-2- |
| (Com- | | methylpropane sulfonic acid, 50 wt % |
| parative) | | in water from Sigma-Aldrich |
| M-11 | | A cross-linker with two acrylamide |
| (Com- | | groups obtained from Fujifilm. Structure |
| parative) | | is shown below, preparation method is |
| | | described in EP2965803. |

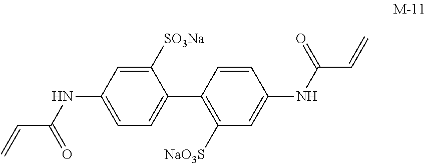

### Synthesis of Et-DVBS

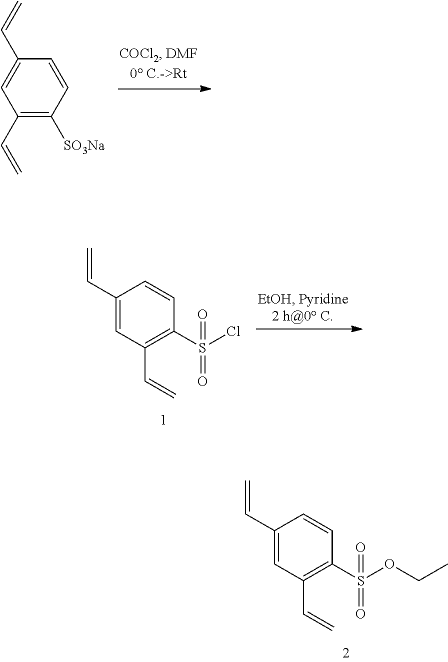

### Step 1

A solution of 2,4-divinylbenzenesulfonic acid sodium salt (145.15 g; 0.625 mol, 1moleq.) and TEMPOL (4-OH-TEMPO; 73 mg, ca. 500 ppm) in DMF (250 mL) was added drop wise within 1 hour to thionylchloride (318 mL, 520 g; 4.375 mol, 7 moleq.) kept at a temperature of 0° C. in an ice bath. After addition was completed, the solution was allowed to slowly heat to room temperature and was stirred for 16 hours. Thereafter, the reaction mixture was poured slowly into ice/water (1.5 L). Toluene (600 mL) was added and the complete mixture was filtered over Celite to remove undissolved material. The water layer was extracted twice with toluene (300 mL), and the combined toluene layers were washed once with a saturated KCl-solution (500 mL). The toluene solution was dried over sodium sulfate, filtrated and concentrated in vacuo to give a yellow oil (ca. 120 gram; 84%). The crude product was used without further purification in the second step. The synthesis was confirmed by 1 H NMR.

### Step 2

A solution of the product obtained in step 1 (120 g; 0.525 mol) and TEMPOL (4-OH-TEMPO; 60 mg, ca. 500 ppm) in pyridine (150 mL) was added dropwise to an ice-cooled (0° C.) stirred solution of ethanol (46 mL, 36 g; 0.787 mol, 1.5 moleq.) in pyridine (75 mL). After two hours stirring in an ice bath of 0° C., the reaction mixture was poured into an ice-cooled 1:1 mixture of ice and concentrated 36%-HCl (600 mL total volume). Chloroform (ca. 800 mL) was added and the mixture was transferred to a separation funnel. The water layer was removed, and the chloroform layer was consecutively washed with a 3M HCl-solution and with a saturated NaCl-solution. The chloroform layer was dried over sodium sulfate and filtrated. TEMPOL (ca. 25 mg; ca. 200 ppm) was added to this filtrate solution that was then concentrated in vacuo to give an orange/brown oil (103 g; 82%). The synthesis was confirmed by ¹H NMR.

Coating compositions comprising EtSS, DVB, LiSS, a solvent and 0.5 wt % of V-65B were prepared according to the compositions CELC 1 to 4 described in the Table 1. The compositions were coated onto a porous substrate and laminated between two PET foils and then were thermally cured in an oven at 70° C. for 16 hrs,. The resulting CEM precursor films PF1 to PF4 were then subjected to a hydrolysis process at 50° C. The hydrolysis conditions and the properties of the resulting cation exchange membranes (CEMs) are shown in Table 2.

TABLE 1
CEL compositions CELC 1 to 4

| | CELC 1 | CELC 2 | CELC 3 | CELC 4 |
|---|---|---|---|---|
| Ingredient | (wt %) | (wt %) | (wt %) | (wt %) |
| DMSO | 9.50 | 19.50 | 19.50 | — |
| IPA | — | — | — | 9.50 |
| EtSS | 60.00 | 50.00 | 45.00 | 60.00 |
| LiSS | — | 10.00 | — | — |
| DVB | 30.00 | 20.00 | — | 30.00 |
| Et-DVBS | — | — | 35.00 | — |
| V-65B | 0.50 | 0.50 | 0.50 | 0.50 |
| polymer content | 84.0% | 65.0% | 75.5% | 84.0% |
| charge density | 2.55 | 2.12 | 3.39 | 2.55 |
| (eq/kg) | | | | |
| cross-link | 2.31 | 1.54 | 1.47 | 2.31 |
| density (mol/kg) | | | | |
| crosslinker | 47.5% | 42.0% | 43.5% | 47.5% |
| content | | | | |

TABLE 2
Hydrolysis of CEM precursor films PF1 to PF4 and properties of the
resultant CEMs

| | Hydrolysis | Time | Intensity IR | Hydrolysis | PS | ER |
|---|---|---|---|---|---|---|
| | solution | (h) | peak (910 cm-¹) | (%) | (NaOH) | (NaCl) |
| PF1 | — | — | 48 | 0 | | |
| | NaOH | 24 | 82 | 100 | 84.2 | 2.0 |
| | H₂SO₄ | 48 | 82 | 100 | 86.4 | 2.5 |
| PF2 | — | — | 44 | 0 | | |
| | NaOH | 24 | 82 | 100 | 71.7 | 1.7 |
| PF3 | | | 48 | 0 | | |
| | NaOH | 72 | 83 | 100 | 82.6 | 1.7 |
| PF4 | | | 46 | 0 | | |
| | NaOH | 120 | 82 | 100 | 95.7 | 3.7 |

* all hydrolytic solutions contained 10% of IPA

### Preparation of the AEL

An AEL composition (AELC1)was prepared containing 58 wt % of 1,4-diazoniabicyclo[2.2.2]octane, 1,4-bis[(4-ethenylphenyl)methyl]-, chloride, 19 wt % of water, 6 wt % of IPA, 1 wt % of Omnirad™ TPO-L and 1 wt % of Omnirad™ 1173. The AEL composition was coated on a non-woven polyethylene fabric and cured by UV to give an AEL.

### Coating of CELs and Application to the AEL to Produce BPMs

CEL compositions were prepared according to Table 3 below. Each CEL composition was coated on the AEL prepared above, then a second non-woven polyethylene fabric was placed onto the layer of CEL composition and excess CEL composition was wiped off. Subsequently, the membrane was placed between PET sheets and cured in an oven at 80° C. for 16 hours. The resultant membrane was placed in a 0.1N NaOH solution with 10% IPA for 72 hours to hydrolyse the —SO₂X (ester) groups into the corresponding sulfonic acid sodium salts to give BPMs.

The electrochemical properties and the bipolar characteristics of these bipolar membranes were compared to a reference membrane using a so-called current-voltage characteristic (I-U curve), where the current density is measured as a function of the applied voltage. Typically, the lower the voltage (U) required to generate a given current density, i.e. 600 mA/cm², the lower is the ionic resistance of one or both ion exchange layers in particular, and the bipolar membrane in general. Low ionic resistance, in this case of the cation exchange layer, results in membranes that are more energy efficient.

TABLE 3
CEL Compositions CELC 5 to 7

| | CELC 5 | CELC 6 | CELC 7 |
|---|---|---|---|
| Ingredient | (wt %) | (wt %) | (wt %) |
| IPA | 9.50 | 7.25 | 5.00 |
| EtSS | 60.00 | 68.25 | 76.50 |
| DVB | 30.00 | 24.00 | 18.00 |
| V-65B | 0.50 | 0.50 | 0.50 |
| total | 100.00 | 100.00 | 100.00 |
| polymer content | 84.0% | 85.4% | 86.9% |
| charge density (eq/kg) | 2.55 | 2.90 | 3.39 |
| cross-link density (mol/kg) | 2.31 | 1.85 | 1.38 |
| crosslinker content | 47.5% | 38.9% | 29.9% |

A Comparative CEL Composition (CExCELC1) was prepared in which the CEL layer of a BPM was obtained from a composition consisting of 30 wt % Na-AMPS (calculated based on pure material), 30 wt % M-11, 39 wt % water and 1 wt % V-65B. In the Comparative BPM the AEL was prepared exactly the same as described for the Examples of the invention.

The resultant BPMs and their properties were as shown in Table 4 below:

TABLE 4
BPMs with characterizing property

| | AEL obtained | CEL obtained | |
|---|---|---|---|
| Example | from: | from: | Voltage* |
| 1 | AELC1 | CELC5 | 2.92 |
| 2 | AELC1 | CELC6 | 2.78 |
| 3 | AELC1 | CELC7 | 2.67 |
| CEx1 | AELC1 | CExCELC1 | 5.45 |

*Voltage displayed by the membranes at 600 mA/m² current density.

1. A membrane comprising an anion exchange layer (AEL) and a cation exchange layer (CEL) wherein the CEL is obtainable by a process comprising 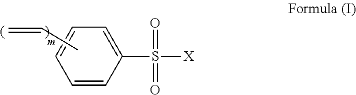
curing a curable composition comprising a compound of Formula (I):
wherein:
X is of the formula —OCₙH₂₊₁ or —OC_{q}H_{2q-1}, wherein n has a value of 1 to 6 and q has a value of 5 or 6; and
m has a value of 1 or 2.

2. The membrane according to claim 1 wherein the composition from which the CEL is obtainable comprises the following ingredients:
(a) the compound of Formula (I);
optionally (b) a compound comprising at least two ethylenically unsaturated groups;
optionally (c) a non-aqueous solvent;
optionally (d) a radical initiator; and
optionally (e) an anionic monomer comprising one and only one ethylenically unsaturated group.

3. The membrane according to claim 1 wherein the curable composition from which the CEL is obtainable comprises:
(a) 20 to 88 wt % of component (a);
(b) 10 to 60 wt % of component (b);
(c) 0 to 30wt % of component (c);
(d) 0 to 2 wt % of component (d);
(e) 0 to 15 wt % of component (e).

4. The membrane according to claim 2 or claim 3 wherein the curable composition from which the CEL is obtainable comprises at least two, especially at least three and more especially all four of components (b), (c), (d) and (e).

5. The membrane according to claim 2 wherein the molar ratio of component (a) and component (b) is in the range 2:1 to 1:2.

6. The membrane according to claim 1 wherein the curable composition from which the CEL is obtainable comprises at least of curable compounds.

7. The membrane according to claim 1 wherein the AEL is obtainable by curing a composition comprising a curable cationic compound.

8. The membrane according to claim 1 wherein the AEL is obtainable by curing a composition comprising the following ingredients:
(a2) a curable cationic compound comprising at least two ethylenically unsaturated groups;
optionally (b2) a compound comprising one and only one ethylenically unsaturated group;
optionally (c2) a solvent; and
optionally (d2) a radical initiator.

9. The membrane according to claim 8 wherein the composition from which the AEL is obtainable comprises:
(i) 30 to 80 wt % of component (a2);
(ii) 0 to 40wt % of component (b2);
(iii) 10 to 40 wt % of component (c2); and
(iv) 0.001 to 2wt % of component (d2).

10. The membrane according to claim 8 wherein the molar ratio of component (a2) to component (b2) is in the range 9:1 to 1:4.

11. The membrane according to claim 8 wherein the AEL is obtainable from a composition comprising component (a2) and at least one, more preferably at least two, especially all three of components (b2), (c2) and (d2).

12. The membrane according to claim 8 wherein component (a2) is of Formula (II): 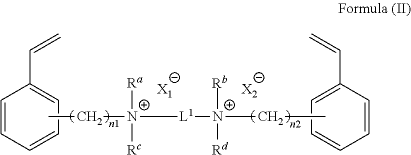
wherein:
L¹ is an alkylene group or an alkenylene group;
R^{a}, R^{b}, R^{c}, and R^{d} are each independently an alkyl group or an aryl group, or R^{a} and R^{b}, and/or R^{c} and R^{d} may, together with the atoms to which they are attached, form a ring;
n1 and n2 each independently represent an integer of 1 to 10; and
X₁⁻ and X₂⁻ each independently represent an anion.

13. A process for manufacturing a membrane comprising the steps:
(i) applying an AEL composition to a support;
(ii) at least partly curing the AEL composition, thereby forming an anion exchange layer (AEL);
(iii) applying an CEL composition to the AEL; and
(iv) curing the CEL composition, thereby forming a cation exchange layer (CEL) on the AEL;
wherein the CEL composition comprises a compound of Formula (I) as defined in claim 1 and the AEL composition comprises a curable cationic compound.

14. The process according to claim 13 wherein the process further comprises the step of hydrolysing at least some the —SO₂X groups in the compounds of Formula (I) to —SO₂OH groups or a salt thereof.

15. The process according to claim 13 wherein the AEL composition is obtained from
(a2) a curable cationic compound comprising at least two ethylenically unsaturated groups;
optionally (b2) a compound comprising one and only one ethylenically unsaturated group;
optionally (c2) a solvent; and
optionally (d2) a radical initiator.

16. The membrane according to claim 1 which is a bipolar membrane.

17. A method of using the membrane according to claim 1 for the production the acids and bases or for the generation of electricity.

18. The membrane according to claim 1 wherein the curable composition from which the CEL is obtainable comprises 20 to 88 wt % of component (a).

19. The membrane according to claim 2 wherein the curable composition from which the CEL is obtainable comprises 10 to 60 wt % of component (b)

20. The membrane according to claim 2 wherein component (b) comprises an aromatic group.

21. The membrane according to claim 2 wherein component (b) comprises at least two (meth)acrylic groups and/or vinyl groups.
